(19) United States
(12) Patent Application Publication
(10) Pub. No.: US 2024/0111489 A1
(43) Pub. Date: Apr. 4, 2024

(54) BIGNUM ADDITION AND/OR SUBTRACTION WITH CARRY PROPAGATION

(71) Applicant: ADVANCED MICRO DEVICES, INC., Santa Clara, CA (US)

(72) Inventors: Onur Kayiran, West Henrietta, NY (US); Michael Estlick, Ft. Collins, CO (US); Masab Ahmad, Austin, TX (US); Gabriel H. Loh, Bellevue, WA (US)

(21) Appl. No.: 17/955,634

(22) Filed: Sep. 29, 2022

(51) Int. Cl. G06F 7/498; G06F 7/506

(52) U.S. Cl. CPC G06F 7/4981; G06F 7/506

(57) ABSTRACT

A processing unit includes a plurality of adders and a plurality of carry bit generation circuits. The plurality of adders add first and second X bit binary portion values of a first Y bit binary value and a second Y bit binary value. Y is a multiple of X. The plurality of adders further generate first carry bits. The plurality of carry bit generation circuits is coupled to the plurality of adders, respectively, and receive the first carry bits. The plurality of carry bit generation circuits generate second carry bits based on the first carry bits. The plurality of adders use the second carry bits to add the first and second X bit binary portions of the first and second Y bit binary values, respectively.

### BACKGROUND

Arbitrary-precision arithmetic (referred to herein as bignum arithmetic) is an important computational primitive in cryptography applications, such as Rivest-Shamir-Adleman (RSA). An important part of these workloads is bignum addition and subtraction on large integers (e.g., 4096 bits). Beyond addition, bignum add operations are primitives used in other bignum operations such as multiplication. As such, recent competing Instruction Set Architectures (ISAs) have defined extensions to accelerate such operations and workloads (e.g., ARM's SVE2, RISC-V's RVV).

ARM SVE2 provides a solution for bignum arithmetic, with ARM having vector add-with-carry top/bottom instructions. While these instructions may work for some cases, due to the lack of vector carry propagation, they do not effectively handle cases where carry propagation needs to run a full width (or more than one vector lane) of the datapath (e.g., across all 512-bits). These instructions need additional software support to chain them together to handle such cases. Moreover, half of the vector lanes remain unused, resulting in poor datapath utilization and therefore unrealized performance potential. RISC-V RVV also provides a solution for bignum arithmetic. Similar to the ARM SVE2 solution, RISC-RVV has vector add-with-carry instructions that require special handling of long-carry cases. AVX-512F additionally provides a solution for bignum arithmetic. AVX-512F instructions are used to perform vector bignum addition and subtraction while handling full-width vector carry propagation. AVX-512F uses an iterative process, which means final carry bits that are used for calculating an accurate sum must be calculated one by one, based on the result of the previous step.

Current bignum workloads typically use libraries like the GNU Multi-Precision (GMP) Library which is based on scalar instructions, which limits their performance. Traditional approaches/circuits are impractical because of the large latency and area required to support carry-propagation across the entire 512-bit datapath. Another problem is that to support even larger integers (e.g., 1024-bit, 4096-bit), two-register outputs per operation would have to be supported (i.e., one for the sum, one for the carry-out to feed into the computation for the next significant 512-bits), but existing datapaths and ISAs only support a single destination/output per instruction.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIGS. 1A and 1B illustrate an example processing unit to generate/propagate carry bits for integer bignum addition (e.g., 512 b), using a 1-bit full adder (FA) and an XOR gate per vector lane, in accordance with some embodiments.

FIGS. 2A and 2B show another example processing unit to generate/propagate carry bits for integer bignum addition (e.g., 512 b), using a Vector Carry Propagation (VCP) circuit per vector lane, in accordance with some embodiments.

FIG. 3 illustrates an example configuration for the 1-bit VCP logic circuits shown in FIGS. 1A and 1B, in accordance with some embodiments.

FIG. 4 shows example hardware components of the processing units from FIGS. 1A and 1B and 2A and 2B that are configured to perform a bignum 512 b addition, in accordance with some embodiments.

FIGS. 5A and 5B illustrate an example processing unit that can perform carry generation/propagation for 2×256 b bignum additions simultaneously, in accordance with some embodiments.

FIGS. 6A and 6B show an example processing unit to generate/propagate carry bits for integer bignum subtraction (e.g., 512 b), in accordance with some embodiments.

FIGS. 7A and 7B illustrate an example processing unit to generate/propagate carry bits for chaining multiple 512 b subtraction operations, in accordance with some embodiments.

FIGS. 8A and 8B show an example processing unit to generate/propagate carry bits for both addition and subtraction of bignums, in accordance with some embodiments.

FIGS. 9A and 9B illustrate an example processing unit that can perform carry generation/propagation for adding and subtracting 2×256 b bignums, in accordance with some embodiments.

FIGS. 10A and 10B show the processing unit illustrated in FIGS. 8A and 8B configured to perform a bignum 512 b addition/subtraction, in accordance with some embodiments.

FIGS. 11A and 11B illustrates yet another configuration for an example processing unit, that builds on the configuration of the processing unit shown in FIGS. 2A and 2B, to add two bignum binary values without having to first store carry bits in a vector register, in accordance with some embodiments.

FIG. 12 shows an example critical path for chained 512 b additions, in accordance with some embodiments.

FIG. 13 illustrates an example method to generate carry bits and add first and second binary values, in accordance with some embodiments.

### DETAILED DESCRIPTION

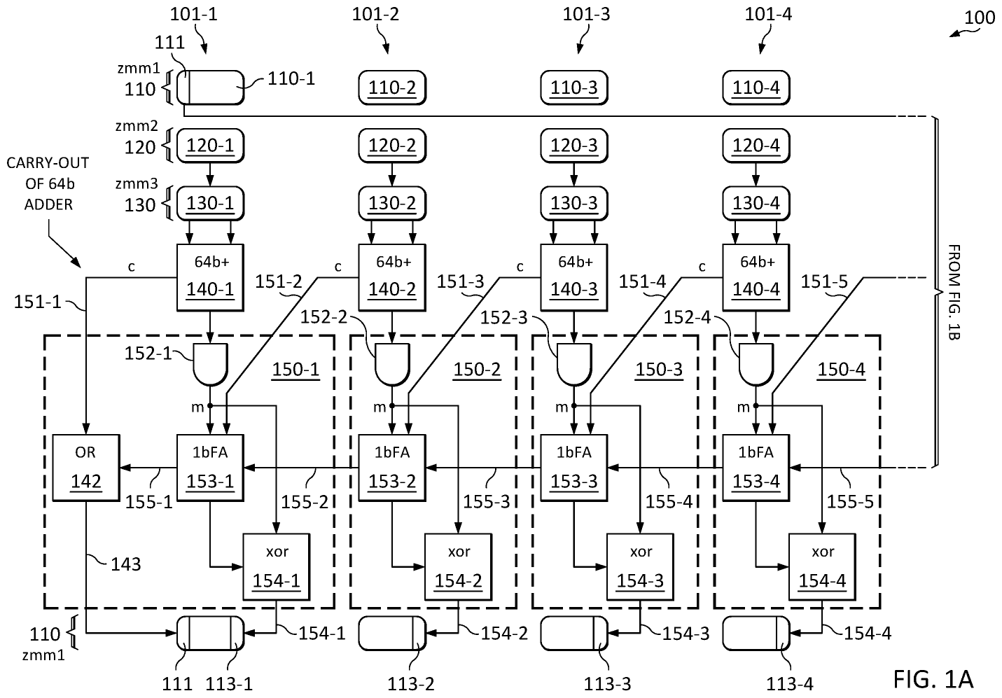

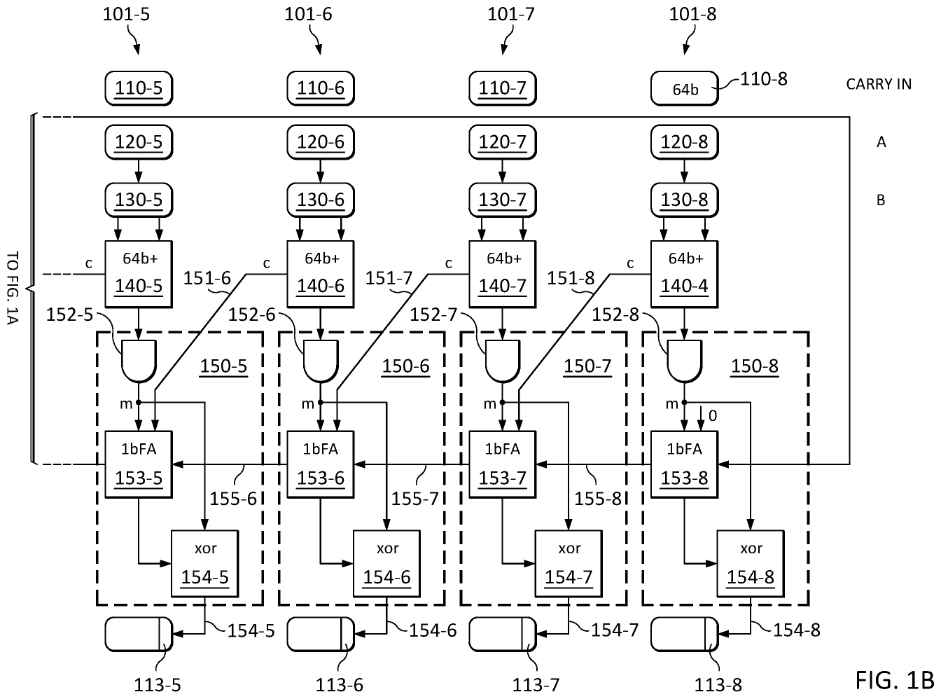

FIGS. 1-13 illustrate techniques for addressing inefficiencies associated with the use of scalar instructions and existing support for a single destination/output per instruction, providing a wide add, e.g., on a Single Instruction, Multiple Data (SIMD) datapath, and handling carry information efficiently and elegantly. Most datapath components in modern CPUs have AVX-512 support (as well as other vector ISAs; although other vector ISA's do not support AVX-512 (by definition)), and test with comparing with MAX_WORD being a computation used in some bignums add algorithms. MAX WORD is a binary number that contains all 1's. The size of the number is defined by the data type (in this use case, it is 64 bits). In some embodiments, a processing unit augments this existing datapath with 1-bit Full Adders (FA) and XOR gates per vector lane, and an OR gate. This total additional logic is small compared to the overall size of the Floating Point (FP) SIMD datapath/execution units. The latency impact of this augmentation is also small, as the routing of a carry-in most significant bit (MSB) in a first vector register can be overlapped with the latency of vector 64-bit adders, and the test of each adder's sum against the MAX_WORD value is a 64-bit AND (or alternatively three levels of 4-input AND gates). The 1-bit FAs are coupled in a ripple-carry fashion, although alternative implementations are possible to optimize for area/performance cost.

The processing unit also introduces a pair of new instructions that accelerates such workloads. The processing unit(s) provides a single-instruction dependency chain for chaining together multiple operations for larger bit widths (e.g., 2048 bits or more), and implements modest modifications to an existing datapath, such as the existing AVX512 FP datapath. The processing unit(s) speeds 512 b bignum additions even over the existing AVX-512F based solution. In some embodiments, the processing unit provides approximately 5× speedup over a scalar 512 b add implementation when adding 100,000 bignums that reside in registers. These operations can be performed with the processing unit in fewer instructions while avoiding using scalar registers that result in performance penalties due to moving data between vector and the scalar registers.

While the processing unit performs bignum addition and subtraction (add/sub) in hardware using AVX-512 registers, in some embodiments the processing unit uses the same approach for generating/propagation carry bits/borrows and then uses those carry bits/borrows to calculate a correct bignum sum/difference for other vector ISAs, such as ARM SVE/SVE2, ARM NEON, RISC-V RVV as well. In some embodiments, the processing unit implements a 512-bit datapath, but in other embodiments the processing unit implements narrower datapaths (e.g., 256 b) or wider datapaths (e.g., 1024 b). The processing unit, for integer bignum add/sub, utilizes hardware to 1) perform vector carry/borrow generation and propagation and 2) use the propagated carry bits/borrows to complete the final arithmetic operation.

Also, vector bignum multiplication relies on reduced radix computation with padded zeros for spilling carry bits and subsequently handling those carry bits using scalar add-with-carry instructions, because carry bits cannot be propagated using existing instructions. With these instructions and hardware support by the processing unit, the processing unit performs bignum multiplication faster because it 1) does not need to do radix conversion twice, 2) does not need padding, and can utilize all bits in the vector Arithmetic-Logic Unit (ALU), and 3) does not specifically need to handle the spilling carry bits because there is no spilling. Therefore, the processing unit significantly accelerates bignum multiplication as well. In some embodiments, the processing unit uses bignum add, multiply and subtract operations to perform bignum division and various other mathematical operators more efficiently than conventional solutions.

If traditional vector addition (e.g., vpaddd) is used, every lane is computed independently of the result/carry of the other lanes. A result of this vector operation (i.e., “vector sum”) can be significantly different than the “real sum”. In some embodiments, the processing unit addresses this deficiency by performing carry-out propagation across all vector lanes to provide an accurate “real sum” in a manner that is not possible using traditional vector addition.

FIGS. 1A and 1, collectively referenced as FIG. 1 illustrates an example processing unit 100 to generate/propagate carry bits for integer bignum addition (e.g., 512 b), using a 1-bit FA and an XOR gate per vector lane. In some other embodiments, other types of multi-bit adders (e.g., carry-lookahead adders) can be used for reasons relating to performance, energy, and area. The processing unit 100 cascades a carry bit from one adder in one vector lane to another vector lane to generate carry bits for adding two bignum values together. The processing unit 100 includes a plurality of vector lanes 101-1-101-8, a first vector register 110, a second vector register 120, and a third vector register 130. In some embodiments, at least one of the vector registers 110, 120, 130 is a memory operand. In some embodiments, at least one of the first, second, and third vector registers 110, 120, 130 is instead traditional memory (e.g., Double Data Rate (DDR) memory, Low-Power DDR (LPDDR), etc.) and/or “fabric-attached memory” (e.g., Computer Express Link (CXL) memory, Gen-Z). Each of the first, second, and third vector registers 110 (“zmm1”), 120 (“zmm2”), 130 (“zmm3”) include a plurality of vector register portions, with the number of vector register portions being equal to the number of the plurality of vector lanes 101-1-101-8.

The first vector register 110 includes vector register portions 110-1-110-8, the second vector register 120 includes vector register portions 120-1-120-8, and the third vector register 130 includes vector register portions 130-1-130-8 disposed within the vector lanes 101-1-101-8, respectively. The first, second, and third vector registers 110, 120, 130 are each configured to store Y bit binary values (not shown), with each of the vector register portions 110-1-110-8, 120-1-120-8, 130-1-130-8 configured to store X bit binary portions (not shown) of the Y bit binary values. In this example, the second vector register 120 stores a bignum value A, the third vector register 130 stores bignum value B, with Y being five hundred twelve (512), X being sixty-four (64), thus Y is an eight (8) times multiple of X, although other multiples are possible.

The vector lanes 101-1-101-8 each further include a datapath that includes a plurality of adders 140-1-140-8, respectively. The adders 140-1-140-8 are configured to add the first and second X bit binary portion values of the first Y bit binary value and the second Y bit binary value. The adders 140-1-140-8 also generate carries or carry bits 151-1-151-8, respectively. In addition to the adders 140-1-140-8, the vector lanes 101-1-101-8 each further include a plurality of carry bit generation circuits 150-1-150-8, coupled to the plurality of adders 140-1-140-8, respectively, to generate carry bits 154-1-154-8, respectively. Beginning with adder 140-8, adder 140-8 generates a carry bit that cascades to vector lane 101-7, adder 140-7 generates a carry bit that cascades to vector lane 101-6, adder 140-6 generates a carry bit that cascades to vector lane 101-5, and so on. The carry bits 154-1-154-8 generated by the carry bit generation circuits 150-1-150-8 are ultimately used to add the first and second Y bit binary values, with any carry bits generated prior to the carry bits 154-1-154-8 being intermediate carry bits—that is, intermediate carry bits that are subsequently used to formulate the carry bits 154-1-154-8.

The vector lanes 101-1-101-8 each also include the plurality of carry bit generation circuits 150-1-150-8 coupled to the adders 140-1-140-8, respectively. The carry bit generation circuits 150-1-150-8 receive the carry bits from neighboring ones of the adders 140-1-140-8 and generate the carry bits 154-1-154-8 based on the carry bits 151-1-151-8, respectively. For example, the carry bit generation circuit 150-1 receives the carry bit 151-2 from the adder 140-2, the carry bit generation circuit 150-2 receives the carry bit 151-3 from the adder 140-3, the carry bit generation circuit 150-3 receives the carry bit 151-4 from the adder 140-4, and so on. The carry bit generation circuits 150-1-150-8 are also configured to receive the addition of the first and second X bit binary portions of the first Y bit binary value and the second Y bit binary value stored by the second and third vector registers 120, 130, respectively. The carry bit generation circuits 150-1-150-8 generate the carry bits 154-1-154-8 based on the addition of the first and second X bit binary portions of the first and second Y bit binary values stored by the second and third vector registers 120, 130, respectively.

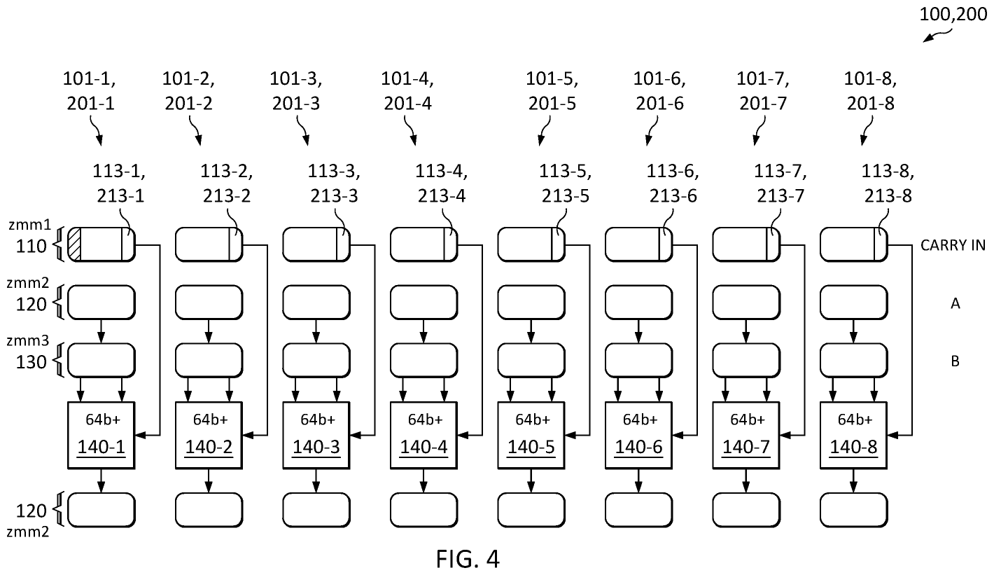

The carry bits 154-1-154-8 are saved in the vector register portions 110-1-110-8 of the first vector register portion 110, respectively. The adders 140-1-140-8 then use the generated carry bits 154-1-154-8 stored by the vector register portions 110-1-110-8, to add the first and second Y bit binary values stored by the second and third vector registers 120, 130, respectively, the details of which will be explained in detail below with respect to FIG. 4.

The carry bit generation circuits 150-1-150-8 take on various configurations in various embodiments, with FIG. 1 showing an example configuration for the carry bit generation circuits 150-1-150-8. In the configuration shown in FIG. 1, the carry bit generation circuits 150-1-150-8 include a plurality of AND logic gates 152-1-152-8 (e.g., 64-bit AND gates), a plurality of 1-bit FAs 153-1-153-8, and a plurality of XOR logic gates 154-1-154-8, respectively. The AND logic gates 152-1-152-8 are configured to receive the addition of the first and second X bit binary portions of the first and second Y bit binary values from the adders 140-1-140-8, respectively. The AND logic gates 152-1-152-8 are further configured to output binary values to the 1-bit FAs 153-1-153-8 and the XOR logic gates 154-1-154-8, respectively. The XOR logic gates 154-1-154-8 are configured to receive the binary values output by the AND logic gates 152-1-152-8 and binary values output by the 1-bit FAs 153-1-153-8, respectively. The XOR logic gates 154-1-154-8 perform logic processing on these received binary values and are further configured to output the carry bits 154-1-154-8 to the first vector register 110, specifically the vector register portions 110-1-110-8, respectively.

The plurality of 1-bit FAs 153-1-153-7 are configurated to receive carry bits 151-2-151-8 from the adders 140-2-140-8, and also configured to receive carry bits 155-2-155-8 from neighboring ones of the 1-bit FAs 152-2-153-7, respectively. By contrast, the 1-bit FA 152-8 is configured to receive a “0” binary value and the MSB 111 of the first vector register 110. For example, the 1-bit FA 152-1 receives carry bits 155-2 from the 1-bit FA 152-2, the 1-bit FA 152-2 receives carry bits 155-3 from the 1-bit FA 152-3, the 1-bit FA 152-3 receives carry bits 155-4 from the 1-bit FA 152-4, and so on. The 1-bit FA 152-8 receives a binary “0” instead of a carry bit from an adder 140, as the other 1-bit FAs 152-1-152-7 receive.

As can be seen in FIG. 1, the carry bit generation circuit 150-1 differs from the carry bit generation circuits 150-2-150-8 in that the carry bit generation circuit 150-1 includes an additional logic circuit. The carry bit generation circuit 150-1 further includes an OR logic gate 142 (e.g., a 64-bit logic OR gate) that receives the carry bit 151-1 from the adder 140-1 and binary values from the 1-bit FA 153-1, and outputs a carry bit 143 to the vector register portion 110-1 of the first vector register 110.

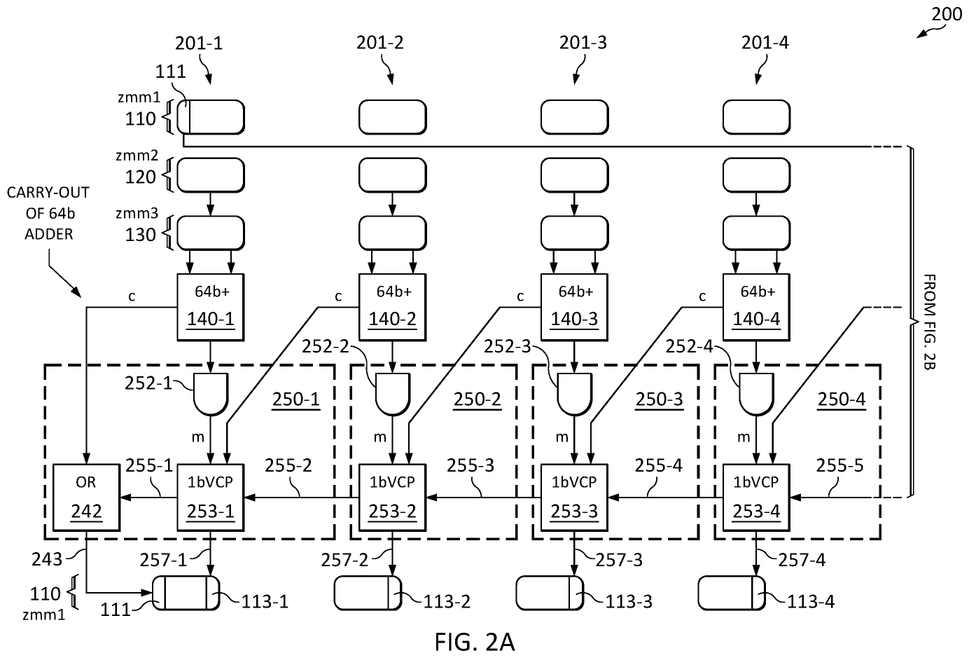

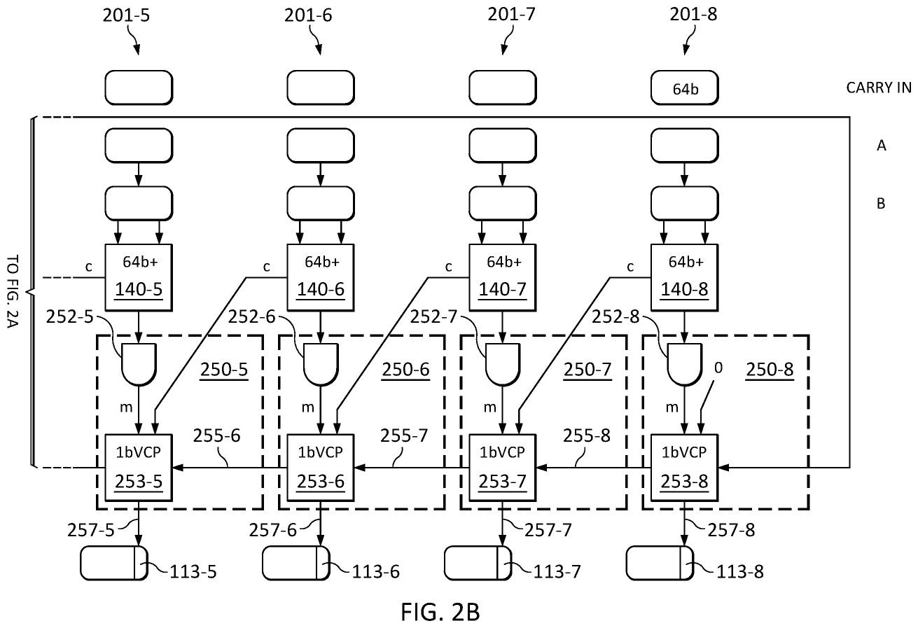

FIGS. 2A and 2B, collectively referenced as FIG. 2 shows another example processing unit 200 to generate/propagate carry bits for integer bignum addition (e.g., 512 b), using a Vector Carry Propagation (VCP) circuit per vector lane. The processing unit 200 includes a datapath including a plurality of vector lanes 201-1-201-8 including another configuration for carry bit generation circuits 250-1-250-8 that include the VCP circuits. The processing unit 200 provides another configuration for generating and propagating carry bits for 512 b integer bignum addition in hardware. The processing unit 400 (FIG. 4) then computes a result of value A+value B+carry as discussed above for processing unit 100 and includes some of the same features shown in FIG. 1. These same features will not be discussed for sake of brevity.

The carry bit generation circuits 250-1-250-8 include a plurality of AND logic gates 252-1-252-8 (e.g., 64-bit AND gates) and a plurality of 1-bit VCP logic circuits 253-1-253-8, respectively. The plurality of AND logic gates 252-1-252-8 are configured to receive the addition of the first and second X bit binary portions of the first and second Y bit binary values from the plurality of adders 140-1-140-8, respectively. The plurality of AND logic gates 252-1-252-8 are also configured to output binary values to the plurality of 1-bit VCP logic circuits 253-1-253-8, respectively.

The plurality of 1-bit VCP logic circuits 253-1-253-8 are configured to receive the binary values output from the plurality of AND logic gates 252-1-252-8, the carry bits from the plurality of adders 140-1-140-8, and the binary values output by neighboring ones of the plurality of 1-bit VCP logic circuits 253-1-253-8, respectively. For example, the carry bit generation circuit 250-1 receives the carry bit 251-2 from the adder 140-2, the carry bit generation circuit 250-2 receives the carry bit 151-3 from the adder 140-3, the carry bit generation circuit 250-3 receives the carry bit 151-4 from the adder 140-4, and so on.

The plurality of 1-bit VCP logic circuits 253-1-253-7 are also configured to output other binary values to other neighboring ones of the plurality of 1-bit VCP logic circuits 253-2-253-8. The plurality of 1-bit VCP logic circuits 253-1-253-8 also output the carry bits 257-1-252-8 to the first vector register 110, particularly the vector register portions 110-1-110-8, respectively, and output carry bits 255-2-255-8 to neighboring ones of the 1-bit VCP logic circuits 253-1-253-7, respectively. The carry bits 257-1-251-8 are placed in the least significant bit 113-1-213-8 of the vector lanes 201-1-201-8, respectively. The 1-bit VCP logic circuit 253-8 receives a binary “0” instead of a carry bit from an adder 140 as the other 1-bit VCP logic circuits 253-1-253-7 receive, and also receive the MSB 111.

For example, the 1-bit VCP logic circuit 253-2 outputs carry bit 255-2 to the 1-bit VCP logic circuit 253-1, the 1-bit VCP logic circuit 253-3 outputs carry bit 255-2 to the 1-bit VCP logic circuit 253-2, the 1-bit VCP logic circuit 253-4 outputs carry bit 255-3 to the 1-bit VCP logic circuit 253-2, and so on.

As can be seen in FIG. 2, the carry bit generation circuit 250-1 is different than the carry bit generation circuits 250-2-250-8 in that the carry bit generation circuit 250-1 includes an additional logic circuit. The carry bit generation circuit 250-1 further includes an OR logic gate 242 (e.g., a 64-bit logic OR gate) that receives the carry bit 251-1 from the adder 140-1 and outputs a carry bit 243 to the vector register portion 110-1 of the first vector register 110. In some embodiments, the carry bit 243 is saved in the MSB 111 of the vector register portion 110-1.

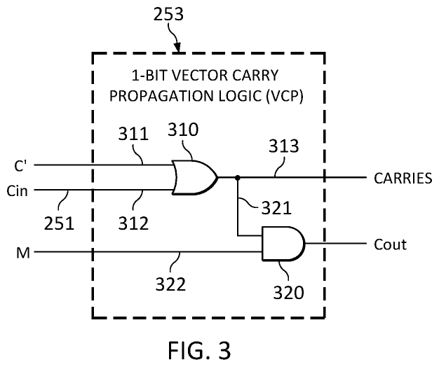

FIG. 3 illustrates an example configuration for the 1-bit VCP logic circuits 253-1 253-8 shown in FIG. 2, collectively referenced as 1-bit VCP logic circuit 253. The 1-bit VCP logic circuit 253 is an optimization to combine the carry generation and propagation into a single (simple) logic block. The 1-bit VCP logic circuit 253 includes an OR logic gate 310 coupled to an AND logic gate 320. The OR logic gate 310 is configured to receive, on a first input 311 thereof, carry bits 251 and, on second input 312 thereof, carry bits 255. The OR logic gate 310 outputs carry bits 257 on an output 313 thereof.

The AND logic gate 320 is configured to receive, on a first input 321 thereof, carry bits 257 from the output 313 of the OR logic gate 310. The AND logic gate 320 is further configured to receive, on a second input 322 thereof, binary values output by AND logic gate 252. The AND logic gate 320 is even further configured to output the carry bits 255.

FIG. 4 shows example hardware components of the processing units 100, 200 from FIGS. 1 and 2 that are configured with another datapath to perform a bignum 512 b addition. The carry bit generation circuits 150-1-150-8, 250-1-250-8 shown in FIGS. 1 and 2, respectively, have been excluded from the illustration for simplicity of explanation. FIG. 4 shows common datapath components from FIGS. 1 and 4, the adders 140. After the carry bits have been generated by either of the processing units 100, 200 and stored in the vector register portions 110-1-110-8 of the first vector register 110, the addition of the bignum A and bignum B can be performed by the adders 140-1-140-8.

Processing units 100, 200, utilizing the datapath shown in FIG. 4, compute a result of value A (e.g., a 512-bit bignum binary value stored in the second vector register 120)+value B (e.g., another 512-bit bignum binary value stored in the third vector register 130)+carry. The processing unit 100 first generates and propagates carry bits. The processing unit 100 performs vector carry generation and propagation for this 512 b addition operation. An instruction to generate/propagate carry bits (generate_carry_512) has three input operands: a value stored at the first vector register 110 (carry, where only a Most Significant Bit (MSB) 111 of the first vector register 110 is used, and all other bits are ignored), a value stored at the second vector register 120 (a first 512-bit bignum value A), and the a value stored at the third vector register 130 zmm3 (storing a second 512-bit bignum B). In some embodiments, some operands can be memory operands instead of register operands. In some embodiments, generate_carry instructions can have versions with implied 0 carry-in values.

The processing units' 100, 200 operational destination register (the first vector register 110) is written with 1) “carry bits” (i.e., the carry bits used in updating the “vector sum” to “real sum”), and 2) the “carry-out” bit of the 512-bit addition operation so that multiple 512 b additions are chained to perform addition on larger numbers (e.g., two 512 b adds can be chained to perform 1024 b addition). These “Carry bits” are placed in the least significant bit 113-1-113-8 of the vector lanes 101-1-101-8, respectively. The “carry-out” bit or carry bit 143 is placed in the MSB 111 of a destination register, such as the first vector register 110, but it can be placed in other unused bits in different embodiments.

A new ISA instruction, added to an existing ISA instruction set, to perform the addition with the adders 140-1-140-8 (complete_wide_add) has three input operands: the carry bits 154-1-154-8, 257-1-257-8 stored by the first vector register 110 in the least significant bits 113-1-113-8 of every vector lanes 101-1-101-8, 201-1-201-8, with the MSB 111 of the first vector register 110 which is used for chaining 512 b adds during generation of the carry bits being ignored, and a 512 b value bignum A stored in the second vector register 120, and a 512 b bignum value B stored in the third vector register 130.

The adders 140-1-140-8 receive portions of the bignum A and portions of the bignum B from the vector lanes 101-1-101-8, 201-1-201-8, respectively. The adders further receive the previously generated carry bits as previously stored in the least significant bits 113-1-113-8 of every vector lanes 101-1-101-8, 201-1-201-8. The adders 140-1-140-8 then add the bignum A with the bignum B using the carry bits from each of the vector lanes 101-1-101-8, 201-1-201-8, respectively, to arrive at appropriate portions of a sum of bignum A and bignum B. The processing units 100, 200 then update the second vector register 120 with the correct sum of this operation. In some embodiments, the first vector register 110 should not be overwritten so that it can be saved to provide the “carry-out” for chaining subsequent additional 512 b adds. Thus, to facilitate bignum additions using existing 64 b adders, such as in a Single Instruction, Multiple Data (SIMD) datapath, the vector lanes 101-1-101-8, 201-1-201-8 are augmented with “carry in's” carry bits that are fed by utilizing bits of the first vector register 110.

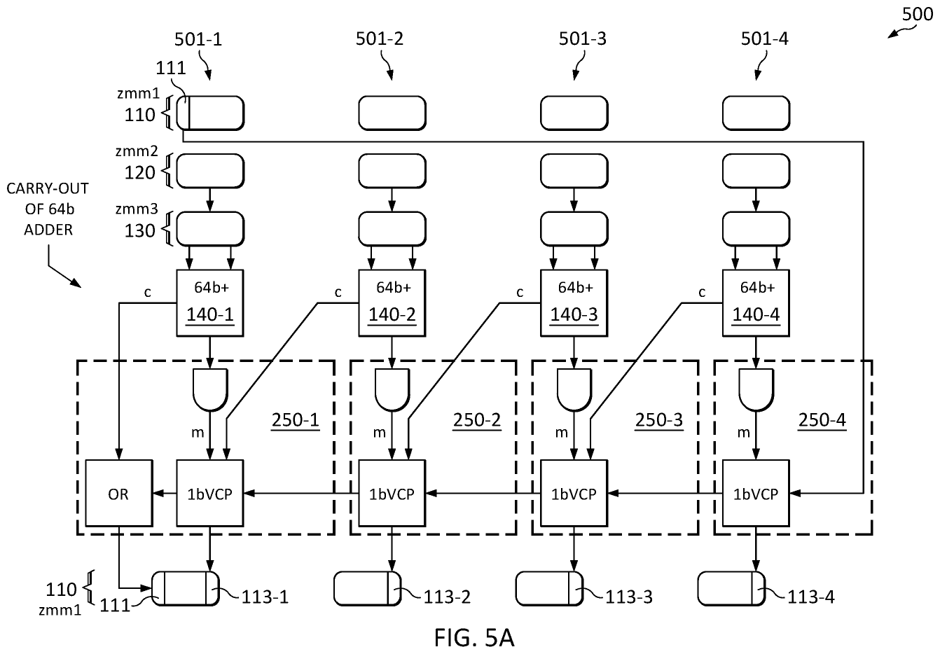

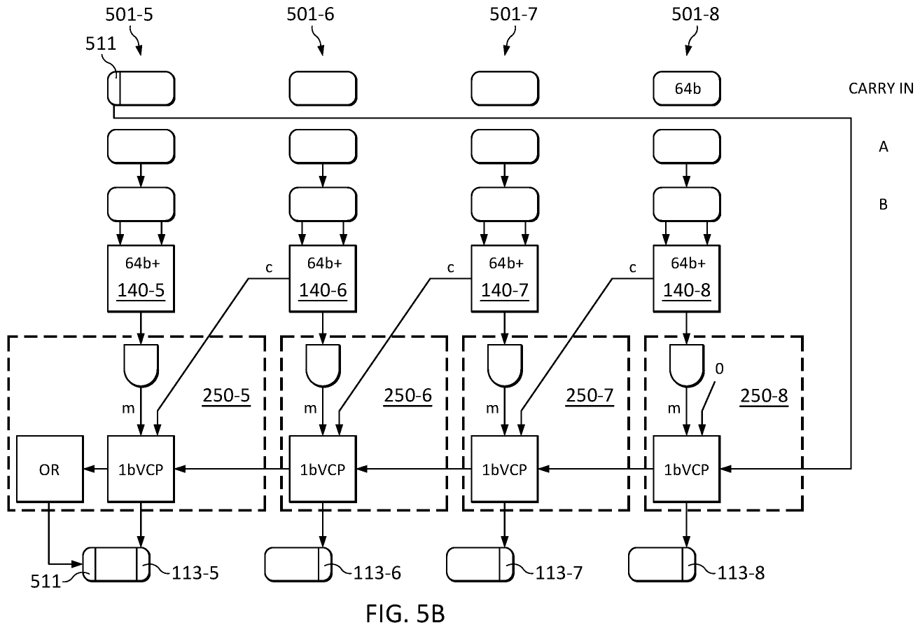

The processing units 100, 200 are configured to generate/propagate carry bits for 512 b bignums. However, the generation/propagation of carry bits discussed above for the addition of bignums can be applied to smaller bignums, such as >64-bits, but <512-bits. FIGS. 5A and 5B, collectively referenced as FIG. 5 illustrates an example processing unit 500 that can perform carry generation/propagation for 2×256 b bignum additions simultaneously.

The processing unit 500 includes a datapath that generates/propagates carry bits for a result of two values of A+two values of B+carry bits for each of the two values. The processing unit 500 includes some of the same features shown in FIG. 1, which will not be discussed for sake of brevity. The processing unit 500 utilizes vector lanes 501-1-501-4 to compute a first A+B+carry, and vector lanes 501-5-501-8 to computer a second A+B+carry, as discussed above in the singular for processing unit 200. Therefore, as the processing unit 500 can generate/propagate carry bits for two additions simultaneously, unique features from the processing unit 200 are replicated.

To perform two carry bit propagations/generations simultaneously, the processing unit 500 includes a second copy of the carry bit generation circuits 250-1. This second copy of the carry bit generation circuits 250-1 is shown in vector lane 501-5 as carry bit generation circuit 550-5. Thus, the vector lanes 501-504 generate carry bits for a first 256 b bignum addition and the vector lanes 501-5-501-8 generate carry bits for a second 256 b bignum addition, doubled as discussed above for FIG. 2 in which the processing unit 200 generates carry bits for a single 512 b bignum addition. Likewise, instead of utilizing a single one of the MSB 111 for generating carry bits that are stored in the least significant bit 113-1-113-8 of the vector lanes 101-1-101-8, the processing unit 500 utilizes the MSB 111 for generating carry bits that are stored in the least significant bit 113-1-113-4 of the vector lanes 501-1-501-4 and another significant bit 511 from vector lane 501-5 for generating carry bits that are stored in the least significant bit 113-1-113-4 of the vector lanes 501-1-501-4.

This concept can be extended to even smaller bignum additions. In some embodiments, instructions generate_carry_256 and generate_carry_128 can perform concurrent 2×256 b additions and 4×128 b additions, respectively. The hardware for generate_carry_256 is shown in FIG. 5. Similarly, generate_carry_128 would utilize two more OR gates and two more bits stored in the first vector register 110. In some embodiments, these 2×256 b and 4×128 b addition operations would not need a different instruction to perform the final completion of the overall addition; the same complete_wide_add instruction discussed above can be used after generate_carry_512/256/128.

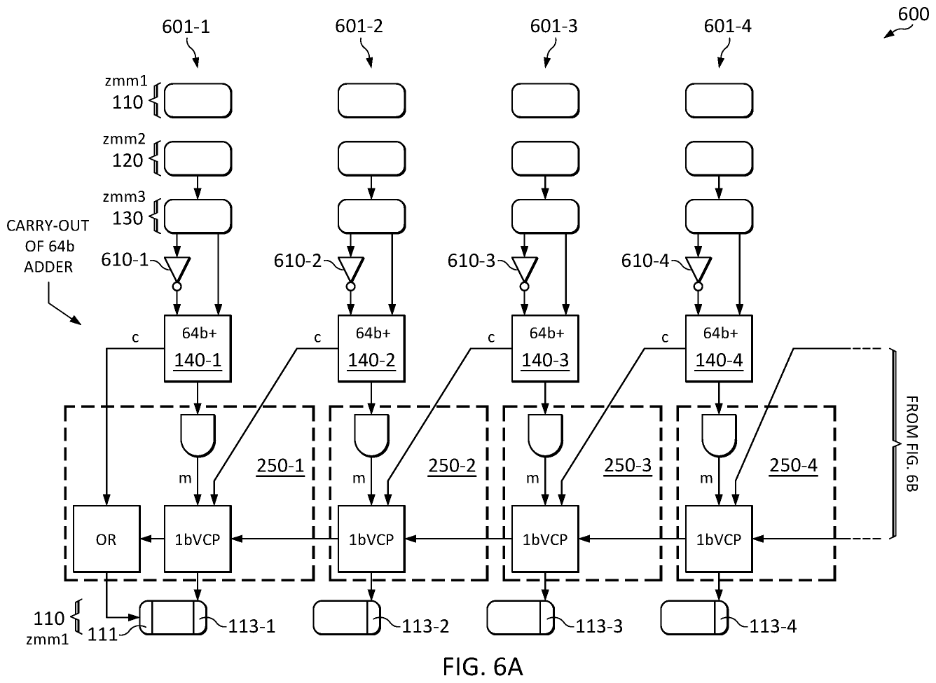

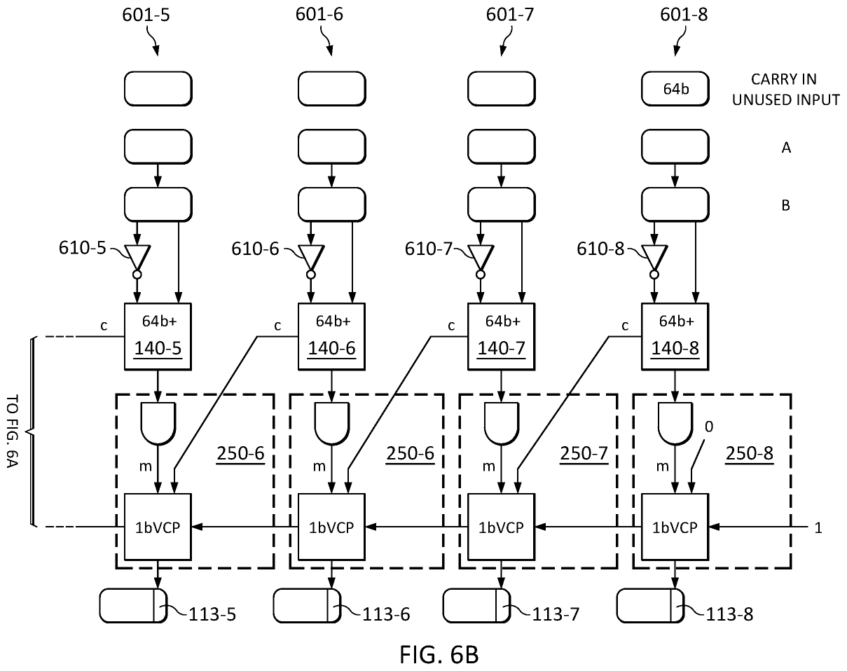

The concepts disclosed above for bignum addition can be extended to bignum subtraction. FIGS. 6A and 6B, collectively referenced as FIG. 6 shows an example processing unit 600 to generate/propagate carry bits for integer bignum subtraction (e.g., 512 b). The processing unit 600 includes a datapath that generates and propagates carry bits for a bignum B stored in the third vector register 130 being subtracted from bignum A stored in the second vector register 120, such as for a generate_sub_carry_512 instruction. Processing unit 600 takes advantage of the fact that A−B=A+(−B), and that −B in 2's complement can be computed by ˜B+1 (bit-wise invert/NOT of B, followed by an increment). FIG. 6 shows a datapath for a generate_sub_carry_512 instruction. In some embodiments, this instruction is used for the first 512 b subtraction operation in a chain of 512 b subtraction operations, where the first vector register 110 is not used as an input. The initial carry 601 into the first “1 b VCP” block is set to 1. B's inverse is taken (1's complement). The initial carry-in bit is used for representing (−B) (2's complement).

Processing unit 600 includes all of the hardware shown in FIG. 2, these same features will not be discussed for sake of brevity. To facilitate generating a complement of bignum B stored in the third vector register 130 so that the processing unit 600 can subtract bignum B from bignum A, the processing unit 600 further includes a plurality of bit-wise invert/NOT logic 610-1-610-8.

The processing unit 600 includes the plurality of bit-wise invert/NOT logic gates 610-1-610-8 for each of vector lanes 601-1-601-8, respectively. The plurality of bit-wise invert/NOT logic gates 610-1-610-8 are coupled to the second vector register 120, particularly the vector register portions 120-1-120-8. The plurality of bit-wise invert/NOT logic gates 610-1-610-8 are configured to receive the 64 b portions of bignum B from the vector register portions 120-1-120-8, respectively, of the second vector register 120. The plurality of bit-wise invert/NOT logic gates 610-1-610-8 perform bit-wise inversion of the 64 b portions of bignum B. The plurality of bit-wise invert/NOT logic gates 610-1-610-8 further output the 64 b portions of bignum B to the plurality of carry bit generation circuits 250-1-250-8, respectively.

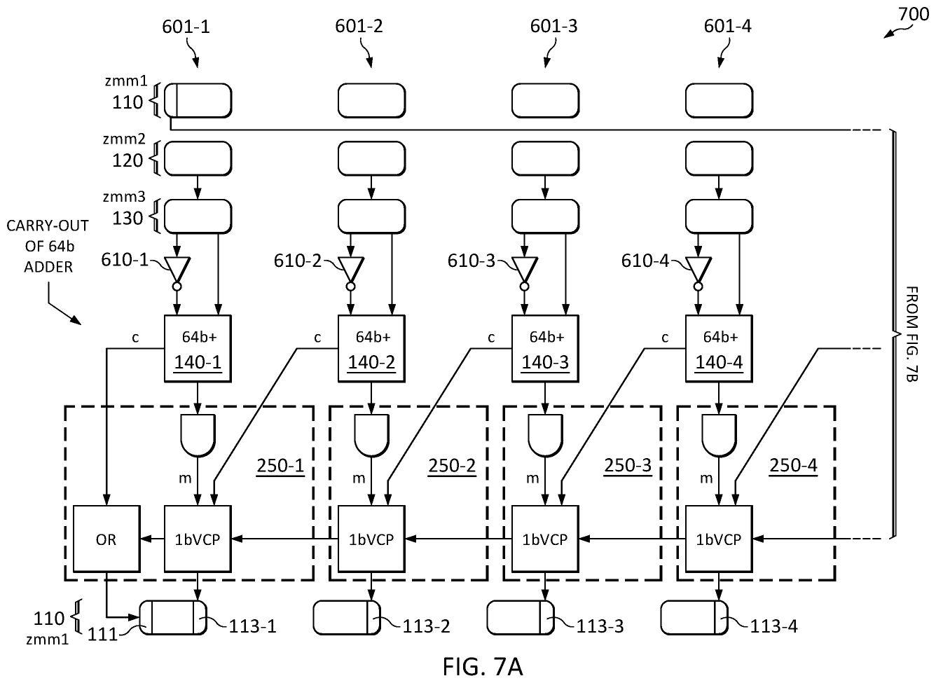

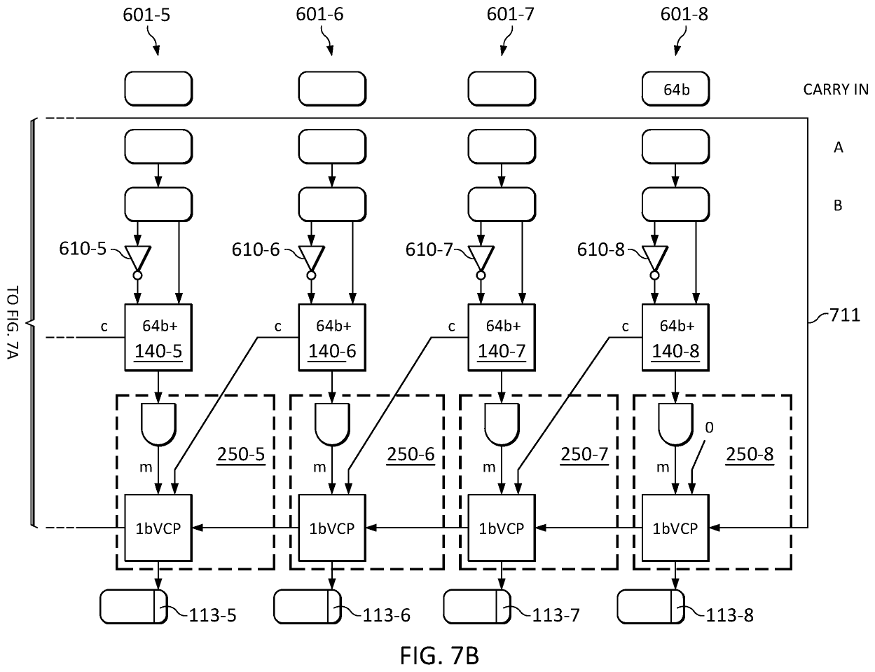

FIGS. 7A and 7B, collectively referenced as FIG. 7 shows an example processing unit 700 to generate/propagate carry bits for chaining multiple 512 b subtraction operations. The processing unit 700 includes another datapath 711 for generating and propagating carry bits for such chained operations. Processing unit 700 includes all of the hardware shown in FIG. 2; these same features will not be discussed for sake of brevity. To facilitate generating a complement of bignum B stored in the third vector register 130 so that the processing unit 700 can generate/propagate carry bits to subtract bignum B from bignum A, the processing unit 600 further includes a plurality of bit-wise invert/NOT logic 610-1-610-8.

Additional carry bits can be generated using a separate generate_sub_carry_chained_512 instruction for all but the first 512 b subtraction. This first instruction does not use the initial carry bit as 1 but instead uses the carry bit set in the MSB 111 of the first vector register 110 which is populated by a previous generate_sub_carrry_(chained)_512 instruction. Thus, the carry bit generation circuit 250-8 receives a carry bit from this previous generate_sub_carrry_(chained)_512 instruction via the datapath 711, which is from the MSB 111 of the first vector register 110. In some embodiments, these two instructions could be combined into one that utilizes a separate static field, for example encoded in an immediate, that controls whether the carry-in should be forced to or whether it should be taken from the first vector register 110.

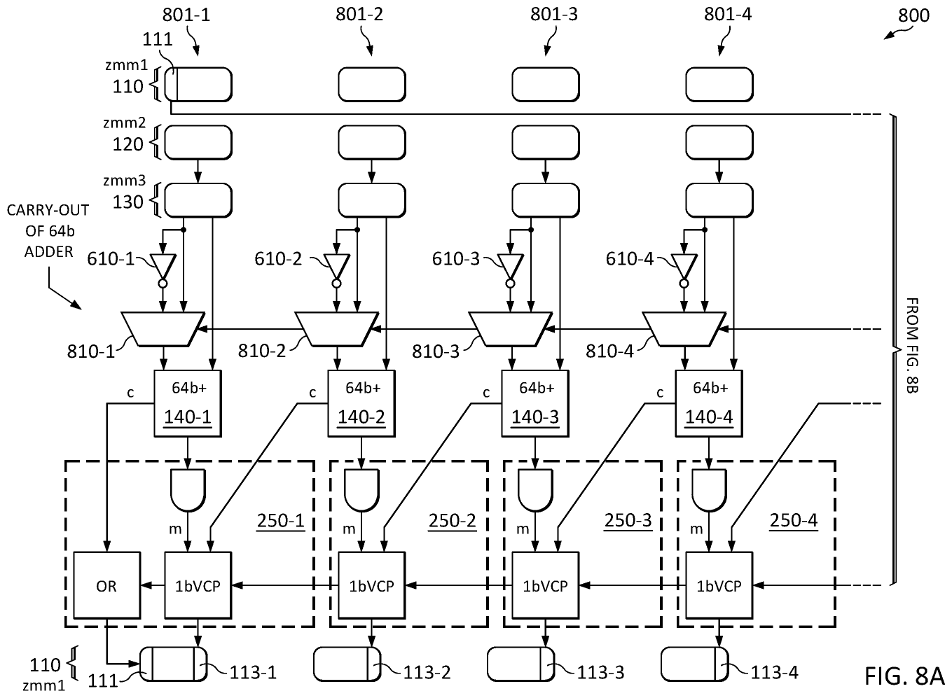

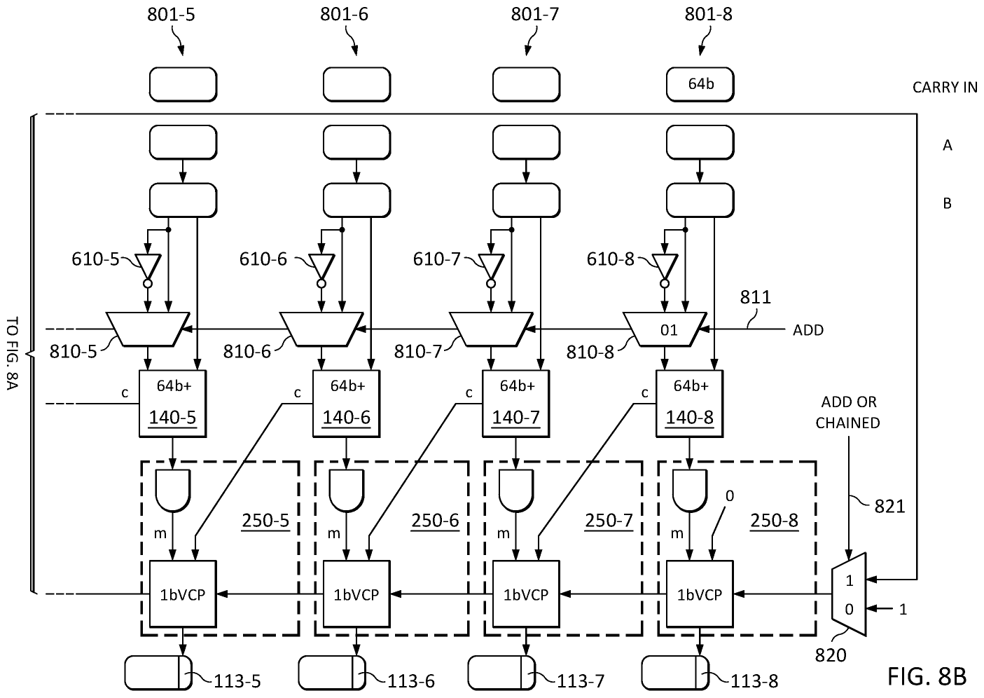

FIGS. 8A and 8B, collectively referenced as FIG. 8 shows an example processing unit 800 that is able to generate/propagate carry bits for both addition and subtraction of bignums. Processing unit 800 includes all of the hardware shown in FIG. 6; these same features will not be discussed for sake of brevity. The processing unit 800 includes a datapath that further includes a plurality of multiplexers 810-1-810-8 for each of the vector lanes 801-1-801-8. The multiplexers 810-1-810-8 are coupled to the second vector register 120, particularly the vector register portions 120-1-120-8, respectively. The plurality of multiplexers 810-1-810-8 are configured to receive the bit-wise inverted X bit binary portions from the plurality of bit-wise invert/NOT logic gates plurality of bit-wise invert/NOT logic 610-1-610-8, respectively. The plurality of multiplexers 810-1-810-8 are configured to further receive the plurality of second X bit binary portions from the vector register portions 120-1-120-8, respectively, of the second vector register 120.

The plurality of multiplexers 810-1-810-8 further receive binary values from neighboring multiplexers 810 and output binary values to other neighboring multiplexers 810, respectively. For example, the multiplexer 810-2 receives binary values from multiplexer 810-3 and outputs binary values to multiplexer 810-1, the multiplexer 810-3 receives binary values from multiplexer 810-4 and outputs binary values to multiplexer 810-2, the multiplexer 810-4 receives binary values from multiplexer 810-5 and outputs binary values to multiplexer 810-3, and so on. The multiplexers 810-1-810-8 further output multiplexed binary values to the adders 140-1-140-8, respectively. The multiplexer 810-1 is different than the other multiplexers in that it only outputs to the adder 140-1, and not to another multiplexer 810. Likewise, the multiplexer 810-8 is different than the other multiplexers 810 in that the multiplexer 810-8 receives a control bit 811 that controls whether an addition or subtraction is being performed by the processing unit 800.

The processing unit 800 even further includes another multiplexer, multiplexer 820. The multiplexer 820 receives a binary “1” on a first input, the MSB 111 from the first vector register 110. The multiplexer 820 further receives a control bit 821 that controls whether the processing unit 800 is processing an add operation (without chaining) or a chained operation. Should the processing unit 800 be configured to perform a chained operation, the multiplexer 820 processes the MSB 111 from the first vector register 110; otherwise the multiplexer 820 processes the binary “1” on its other input.

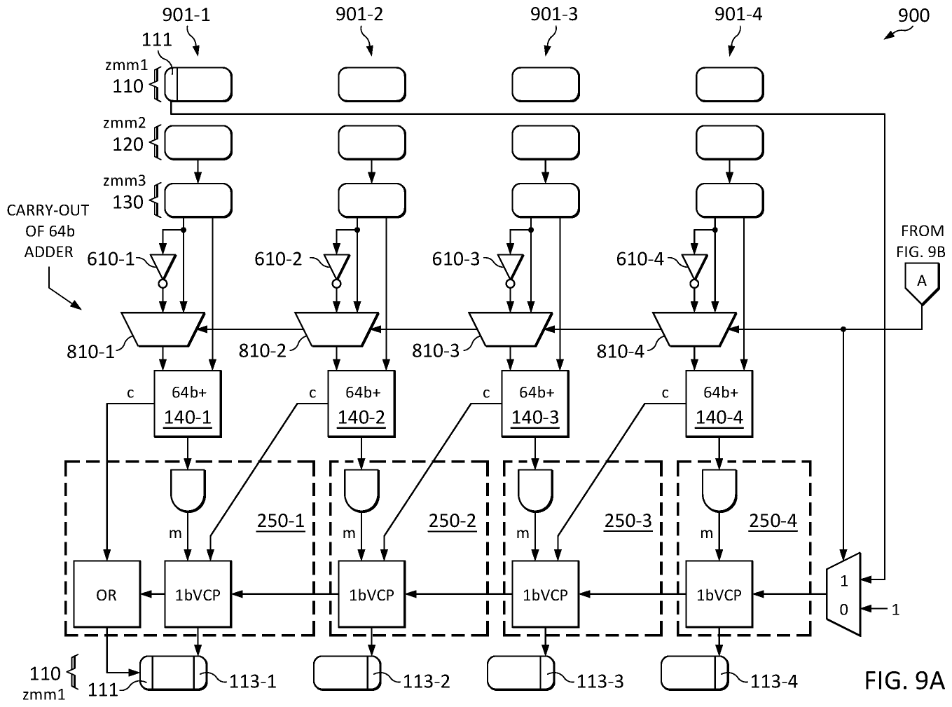

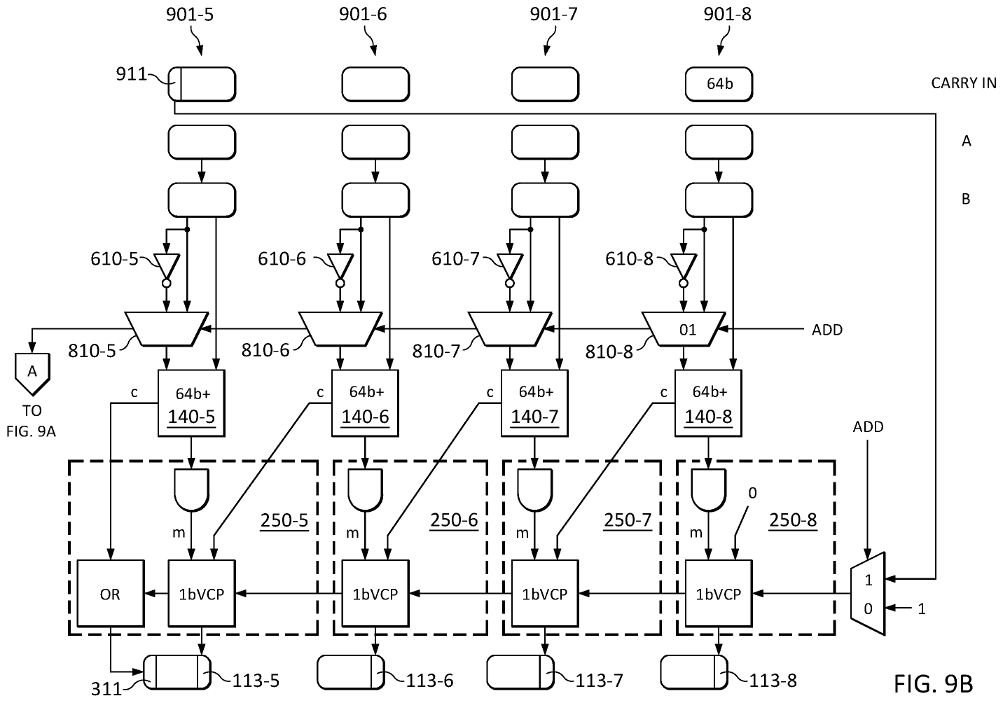

The processing unit 800 is configured to generate/propagate carry bits to add and subtract two 512 b bignums, A+/−B. However, the generation of carry bits discussed above for the addition and subtraction of bignums can be applied to smaller bignums, such as >64-bits, but <512-bits. FIGS. 9A and 9B, collectively referenced as FIG. 9 illustrates an example processing unit 900 that can perform carry generation/propagation for adding and subtracting 2×256 b bignums.

The processing unit 900 computes a result of two values of A+two values of B+carry bits for each of the two values. The processing unit 900 includes some of the same features shown in FIG. 8; these same features will not be discussed for sake of brevity. The processing unit 900 includes a datapath that utilizes vector lanes 901-1-901-4 to compute a first A+/−B+carry, and vector lanes 901-5-901-8 to computer a second A+/−B+carry, as discussed above in the singular for processing unit 800. Therefore, as the processing unit 900 can perform generation/propagation of carry bits for two additions/subtractions simultaneously; unique features from the processing unit 800 are replicated.

To generate/propagate carry bits for these two additions/subtractions simultaneously, the processing unit 900 includes a second copy of the carry bit generation circuits 250-1. This second copy of the carry bit generation circuits 250-1 is shown in vector lane 901-5 as of carry bit generation circuit 950-5. Thus, the vector lanes 901-904 generate carry bits for a first 256 b bignum addition/subtraction and the vector lanes 901-5-901-8 generate carry bits for a second 256 b bignum addition/subtraction, double as discussed above for FIG. 8 in which the processing unit 800 generates carry bits for a single 512 b bignum addition/subtraction. Likewise, instead of utilizing a single one of the MSB 111 for generating carry bits that are stored in the least significant bit 113-1-113-8 of the vector lanes 101-1-101-8, the processing unit 900 utilizes the MSB 111 for generating carry bits that are stored in the least significant bit 113-1-113-4 of the vector lanes 901-1-901-4 and another significant bit 911 from vector lane 901-5 for generating carry bits that are stored in the least significant bit 113-1-113-4 of the vector lanes 901-1-901-4. To perform 128 b or 256 b subtractions, the initial carry-in bit for all bignums is set to 1, as shown in FIG. 9 with the 2x256 b subtraction example.

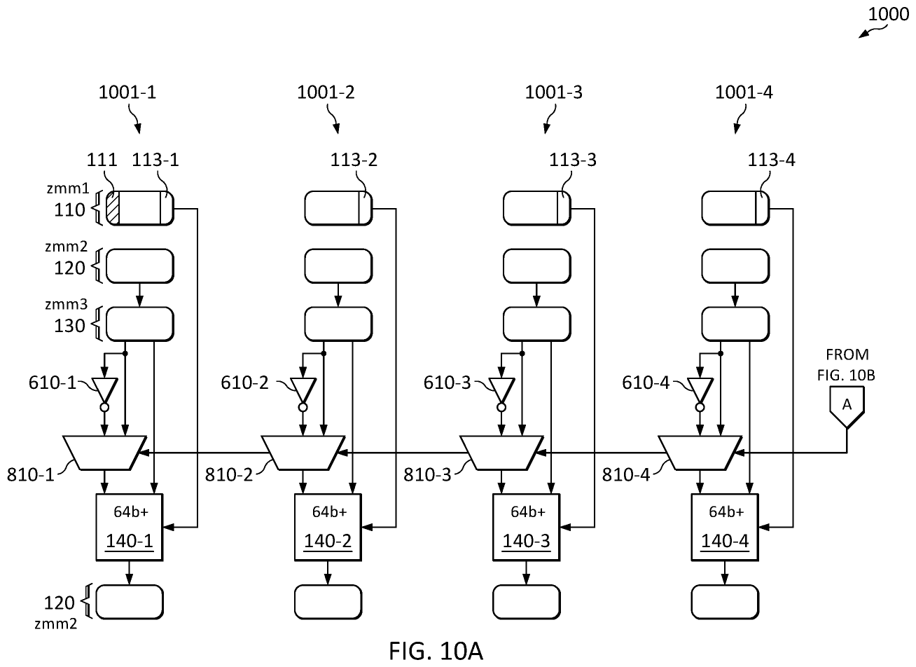

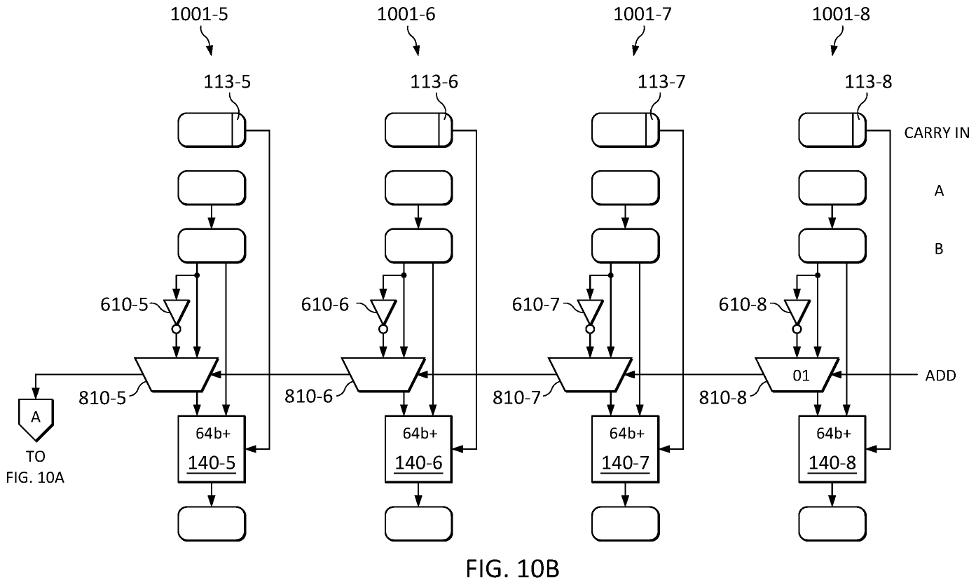

FIGS. 10A and 10B, collectively referenced as FIG. 10 shows the processing unit 800 illustrated in FIG. 8 configured to perform a bignum 512 b addition/subtraction. The carry bit generation circuits 250-1-250-8 shown in FIG. 8, respectively, have been excluded from the illustration for simplicity of explanation. After the carry bits have been generated by the processing unit 800 and stored in the vector register portions 110-1-110-8 of the vector register 110, the processing unit 800 includes a datapath with which the addition/subtraction of the bignum A and bignum B can be performed by the adders 140-1-140-8. The combination of the multiplexers 810-1-810-8 and the bit-wise invert/NOT logic 610-1-610-8 control whether a bit-wise inverted version of the bignum B is received by the adders 140-1-140-8 to perform a subtraction, versus a non-bit-wise inverted version of bignum B to perform an addition.

A new ISA instruction, added to an existing ISA instruction set, to perform the addition/subtraction with the adders 140-1-140-8 (complete_wide_add/sub) has three input operands: (1) the carry bits 257-1-257-8 stored by the first vector register 110 in the least significant bits 113-1-113-8 of every vector lane 801-1-801-8, with the MSB 111 of the first vector register 110 which is used for chaining 512 b addition/subtraction during generation of the carry bits being ignored, (2) a 512 b value bignum A stored in the second vector register 120, and (3) a 512 b bignum value B stored in the third vector register 130.

The adders 140-1-140-8 receive portions of the bignum A and portions of the bignum B from the vector lanes 801-1-801-8, respectively. The adders 140-1-140-8 further receive the previously generated carry bits as previously stored in the least significant bits 113-1-113-8 of every vector lanes 801-1-801-8. The adders 140-1-140-8 then add/subtract the bignum A with the bignum B using the carry bits from each of the vector lanes 801-1-801-8, respectively, to arrive at appropriation portions of a sum of bignum A and bignum B. The processing unit 800 then updates the second vector register 120 with the correct sum/difference of this operation. In some embodiments, the first vector register 110 should not be overwritten so that it can be saved to provide the “carry-out” for chaining subsequent additional 512 b adds/subtractions. Thus, to facilitate bignum additions/subtractions using existing 64 b adders, such as in a Single Instruction, Multiple Data (SIMD) datapath, existing 64 b adders are augmented with “carry in's” or carry bits that are fed by utilizing bits of the first vector register 110.

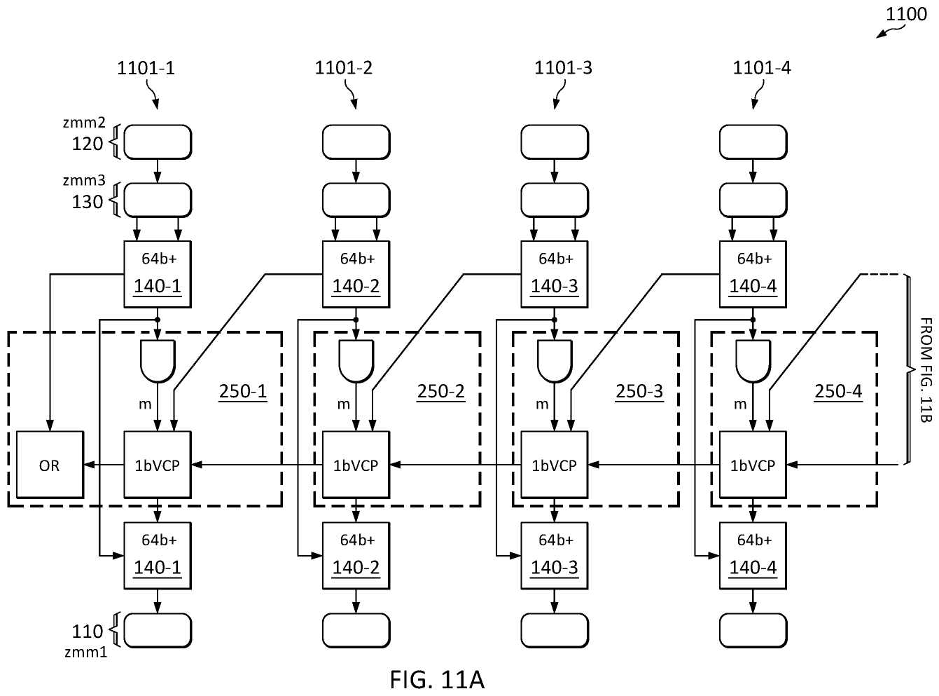

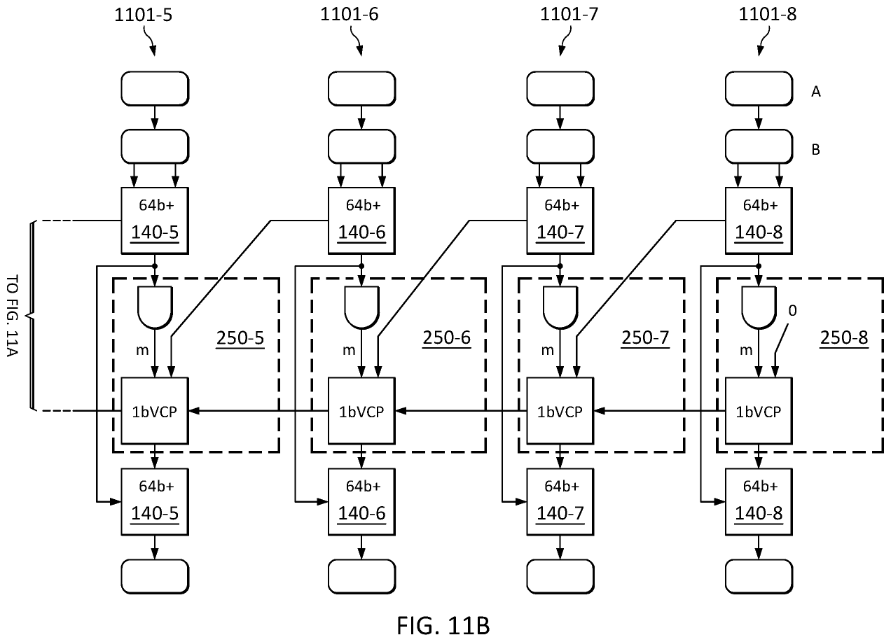

FIGS. 11A and 11B, collectively referenced as FIG. 11 illustrates yet another configuration for an example processing unit 1100, that builds on the configuration of the processing unit 200 shown in FIG. 2, to add two bignum binary values without having to first store carry bits in a vector register. If the MSB 111 from the first vector register 110 (“zmm1”) is not needed to chain a computation of bignums to larger integers (i.e., when all the operations in the computation required <=512 b additions), then the first vector register 110 is not needed to store carry bits to a next stage. The processing unit 1100 can be used in such an instance to include a datapath to perform both carry generation and then bignum addition using a single instruction, such as zmm1=zmm2+zmm3.

Processing unit 1100 includes all of the hardware shown in FIG. 6; these same features will not be discussed for sake of brevity. However, instead of the carry bit generation circuits 250-1-250-8 outputting carry bits to the first vector register 110, particularly vector register portions 110-1-110-8, respectively, as described above for FIG. 2, the processing unit 1100 utilizes carry bit generation circuits 250-1-250-8 that output carry bits to adders, such as adders 1140-1-1140-8. The adders 1140-1-1140-8 receive the binum A, the bignum B, and carry bits from the carry bit generation circuits 250-1-250-8. The adders 1140-1-1140-8 are then able to add the bignum A+bignum B using the carry bits received from carry bit generation circuits 250-1-250-8 to arrive at a correct sum of bignum A+bignum B.

The processing unit 1100 shows two adders 140-1/1140-1, 140-2/1140-2, 140-3/1140-3, 140-4/1140-4, 140-5/1140-5, 140-6/1140-6, 140-7/1140-7, 140-8/1140-8 (e.g., 64 b+ adder blocks) per vector lane 1101-1-1101-8, respectively. In one embodiment, the adders 140-1/1140-1, 140-2/1140-2, 140-3/1140-3, 140-4/1140-4, 140-5/1140-5, 140-6/1140-6, 140-7/1140-7, 140-8/1140-8 are distinct from each other, with the processing unit 1100 utilizing two adders per vector lane 1101-1-1101-8, respectively. In another embodiment, the adders 140 are the same components as adders 1140, with the adders 140 being reused in an instruction in a pipelined fashion. In this embodiment the same adders 140/1140 would thus be used for both generating carry bits and adding bignums A+B.

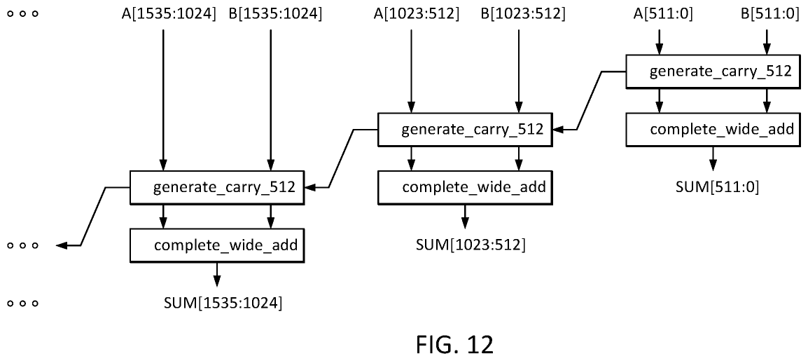

FIG. 12 shows an example critical path for chained 512 b additions. Even though the 512 b addition operation uses two instructions, chaining them together to perform addition on larger integers can be faster in terms of additions/cycle, because the critical path to perform the computation is only one instruction (generate_carry_512).

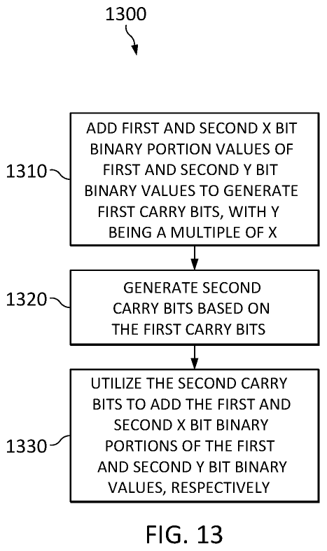

FIG. 13 illustrates an example method 1300 to generate carry bits and add first and second binary values. The method begins with block 1310. At block 1310, first and second X bit binary portion values of a first Y bit binary value and a second Y bit binary value and to generate first carry bits, with Y being a multiple of X. In some embodiments, the adders 140-1-140-8 are used to add first and second X bit binary portion values of a first Y bit binary value and a second Y bit binary value. In accordance with the examples given above, the first Y bit binary value can be the 512 b bignum A and the second Y bit binary value can be the 512 b bignum B. In some embodiments, the first carry bits can be carry bits 151-1-151-8.

At block 1320, second carry bits are generated based on the first carry bits. In some embodiments, the carry bit generation circuits 150-1-150-8, 250-1-250-8 are used to generate the second carry bits. In some embodiment, the second carry bits can be carry bits 154-1-154-8, 257-1-257-8.

At block 1330, the second carry bits are utilized to add the first and second X bit binary portions of the first and second Y bit binary values, respectively. In some embodiments, the adders 140-1-140-8 add the 64 b portions of the 512 b bignums A, B using the carry bits 154-1-154-8, 257-1-257-8. The adders 140-1-140-8 can receive the carry bits 154-1-154-8, 257-1-257-8 from the vector register portions 110-1-110-8, respectively, of the first vector register 110.

The processing units 100-1100 can chain 512 b operations to perform addition on bignums even larger than 512 b, such as 1024 b. The following pseudo code can be used to chain two 512 b additions to perform a 1024 b addition:
mov zmm1, [zeros]; set initial carry-in to zero
mov zmm2, [ALO]; lower 512 b of 1024 b operand A
mov zmm3, [BLO]; lower 512 b of 1024 b operand B
generate_carry_512 zmm1, zmm2, zmm3; zmm1=carry bits
complete_wide_add zmm2, zmm3, zmm1; zmm2=sum
mov zmm4, [AHI]; upper 512 b of 1024 b operand A
mov zmm5, [BHI]; upper 512 b of 1024 b operand B
generate_carry_512 zmm1, zmm4, zmm5; zmm1=carry bits
complete_wide_add zmm4, zmm5, zmm1; zmm4=sum
; DONE: lower 512 b sum in zmm2, upper 512 b in zmm4
; zmm1 holds carryout of 1024 b add if addition additions are to be performed

In some embodiments, the apparatus and techniques described above are implemented in a system including one or more integrated circuit (IC) devices (also referred to as integrated circuit packages or microchips), such as the processing units 100-1100 described above with reference to FIGS. 1-11. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by one or more processors, manipulate one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing unit comprising:
a plurality of adders to add first and second X bit binary portion values of a first Y bit binary value and a second Y bit binary value to generate first carry bits, with Y being a multiple of X; and
a plurality of carry bit generation circuits, coupled to the plurality of adders, respectively, to receive the first carry bits and generate second carry bits based on the first carry bits;
wherein the second carry bits are used to add the first and second X bit binary portions of the first and second Y bit binary values, respectively.

2. The processing unit of claim 1, wherein the plurality of carry bit generation circuits is configured to receive the addition of the first and second X bit binary portions of the first Y bit binary value and the second Y bit binary value, respectively, and to generate the second carry bits based on the addition of the first and second X bit binary portions of the first and second Y bit binary values.

3. The processing unit of claim 1, wherein the first and second Y bit binary values are stored by at least one of a vector register, a memory operand, Double Data Rate (DDR) memory, Low-Power DDR (LPDDR), and Gen-Z.

4. The processing unit of claim 1, wherein a new Instruction Set Architecture (ISA) instruction is added to an existing ISA instruction set to add the first and second X bit binary portions of the first and second Y bit binary values.

5. The processing unit of claim 1, wherein the plurality of carry bit generation circuits comprise:
a plurality of AND logic gates, respectively,
a plurality of 1-bit full adders, respectively; and
a plurality of XOR logic gates, respectively; wherein
the plurality of AND logic gates is configured to:
receive the addition of the first and second X bit binary portions of the first and second Y bit binary values from the plurality of adders, respectively; and
output binary values to the plurality of 1-bit full adders and the plurality of XOR logic gates, respectively;
the plurality of 1-bit full adders is configured to:
receive the binary values output from the plurality of AND logic gates, the first carry bits from the plurality of adders, and binary values from neighboring 1-bit full adders; and
output binary values; and
the plurality of XOR logic gates is configured to:
receive the binary values output by the plurality of AND logic gates and the binary values output by the plurality of 1-bit full adders; and
output the second carry bits to a vector register.

6. The processing unit of claim 1, wherein the plurality of carry bit generation circuits comprise:
a plurality of AND logic gates; and
a plurality of 1-bit Vector Carry Propagation (VCP) logic circuits; wherein the plurality of AND logic gates is configured to:
receive the addition of the first and second X bit binary portions of the first and second Y bit binary values from the plurality of adders; and
output binary values to the plurality of 1-bit Vector Carry Propagation (VCP) logic circuits, respectively; and
the plurality of 1-bit VCP logic circuits is configured to:
receive the binary values from the plurality of AND logic gates, the first carry bits from the plurality of adders, and the binary values output by neighboring ones of the plurality of 1-bit VCP logic circuits;
output other binary values to other neighboring ones of the plurality of 1-bit VCP logic circuits; and
output the second carry bits to a vector register.

7. The processing unit of claim 6, wherein the plurality of AND logic gates are a plurality of first AND logic gates and the 1-bit VCP logic circuits comprise:
a plurality of OR logic gates, respectively; and
a plurality of second AND logic gates, respectively;
wherein the plurality of OR logic gates is configured to receive the binary values output from the plurality of first AND logic gates and the first carry bits from the plurality of adders, respectively; and
wherein the plurality of second AND logic gates is configured to:
receive the first carry bits from the plurality of adders and the binary values output by the plurality of OR logic gates; and
output the second carry bits to the vector register, respectively.

8. The processing unit of claim 6, wherein the vector register is a first vector register, the processing unit further comprises:
a plurality of bit-wise invert/NOT logic gates, coupled to a second vector register, configured to receive the second X bit binary portions, to bit-wise invert the second X bit binary portions of the second Y bit binary value, and to output the bit-wise inverted X bit binary portions of the second X bit binary portions to the plurality of carry bit generation circuits, respectively.

9. The processing unit of claim 8, wherein the plurality of carry bit generation circuits further comprise:
a plurality of multiplexers, coupled to a second vector register, configured to receive the bit-wise inverted X bit binary portions of the second Y bit binary value from the plurality of bit-wise invert/NOT logic gates, to receive the second X bit binary portions, to receive binary values from neighboring multiplexers, and to output binary values to other neighboring multiplexers, respectively.

10. A system including the processing unit of claim 1, the system comprising another processing unit, the another processing unit comprising the plurality of adders and the plurality of carry bit generation circuits.

11. The processing unit of claim 1, further comprising:
a vector register to store the additions of the first and second X bit binary portions of the first and second Y bit binary values, respectively.

12. The processing unit of claim 11, wherein plurality of adders is a first plurality of adders, the processing unit comprising:
a second plurality of adders to add the first and second Y bit binary values from first and second vector registers, respectively.

13. The processing unit of claim 12, wherein the plurality of adders add the first and second Y bit binary values from the first and second vector registers, respectively.

14. A method comprising:
adding, by a plurality of adders, first and second X bit binary portion values of first and second Y bit binary values to generate first carry bits, with Y being a multiple of X;
generating, by a plurality of carry bit generation circuits, second carry bits based on the first carry bits; and
utilizing the second carry bits to add the first and second X bit binary portions of the first and second Y bit binary values, respectively.

15. The method of claim 14, further comprising:
receiving, by the plurality of carry bit generation circuits, the addition of the first and second X bit binary portions of the first Y bit binary value and the second Y bit binary value, respectively; and
generating, by the plurality of carry bit generation circuits, the second carry bits based on the addition of the first and second X bit binary portions of the first and second Y bit binary values.

16. The method of claim 14, further comprising storing the first and second Y bit binary values by at least one of a vector register, a memory operand, Double Data Rate (DDR) memory, Low-Power DDR (LPDDR), and Gen-Z.

17. The method of claim 14, wherein each of the carry bit generation circuits comprise a plurality of AND logic gates; a plurality of 1-bit full adders; and a plurality of XOR logic gates, the method further comprising:
receiving, by the plurality of AND logic gates, the addition of the first and second X bit binary portions of the first and second Y bit binary values from the plurality of adders, respectively;
outputting, by the plurality of AND logic gates, binary values to the plurality of 1-bit full adders and the plurality of XOR logic gates, respectively;
receiving, by the plurality of 1-bit full adders, the binary values output from the plurality of AND logic gates, the first carry bits from the plurality of adders, and binary values from neighboring 1-bit full adders;
outputting, by the plurality of 1-bit full adders, binary values, respectively;
receiving, by the plurality of XOR logic gates, the binary values output by the plurality of AND logic gates and the binary values output by the plurality of 1-bit full adders, respectively; and
outputting, by the plurality of XOR logic gates, the second carry bits to a vector register.

18. The method of claim 14, wherein each of the carry bit generation circuits comprise a plurality of AND logic gates and a plurality of 1-bit Vector Carry Propagation (VCP) logic circuits, the method further comprising:
receiving, by the plurality of AND logic gates, the addition of the first and second X bit binary portions of the first and second Y bit binary values from the plurality of adders, respectively;
outputting, by the plurality of AND logic gates, binary values to the plurality of 1-bit Vector Carry Propagation (VCP) logic circuits, respectively;
receiving, by the plurality of 1-bit VCP logic circuits, the binary values from the plurality of AND logic gates, the first carry bits from the plurality of adders, and the binary values output by neighboring ones of the plurality of 1-bit VCP logic circuits, respectively; and
outputting, by the plurality of 1-bit VCP logic circuits, other binary values to other neighboring ones of the plurality of 1-bit VCP logic circuits and to output the second carry bits to a vector register.

19. The method of claim 14, storing, by a vector register, the additions of the first and second X bit binary portions of the first and second Y bit binary values, respectively.

20. A processing unit comprising:
a first vector register to store a first Y bit binary value comprising a plurality of first X bit binary portions, with Y being a multiple of X;
a second vector register to store a second Y bit binary value comprising a plurality of second X bit binary portions;
a plurality of adders to add first and second X bit binary portion values of the first Y bit binary value and the second Y bit binary value to generate first carry bits; and
a plurality of carry bit generation circuits, coupled to the plurality of adders, respectively, to receive the first carry bits and generate second carry bits based on the first carry bits;
wherein the plurality of adders use the second carry bits to add the first and second X bit binary portions of the first and second Y bit binary values, respectively.
